(19) United States
(12) Patent Application Publication
(10) Pub. No.: US 2024/0251286 A1
(43) Pub. Date: Jul. 25, 2024

(54) BUFFER STATUS REPORTING MESSAGE

(71) Applicant: QUALCOMM Incorporated, San Diego, CA (US)

(72) Inventor: Linhai HE, San Diego, CA (US)

(21) Appl. No.: 18/409,135

(22) Filed: Jan. 10, 2024

Related U.S. Application Data
(60) Provisional application No. 63/481,377, filed on Jan. 24, 2023.

(51) Int. Cl. H04W 28/02; H04W 24/02; H04W 28/08

(52) U.S. Cl. CPC H04W 28/0278; H04W 24/02; H04W 28/0942

(57) ABSTRACT

A user equipment (UE) may receive data, for transmission, at a buffer of the UE, such as when data is generated by an application of the UE. The UE may periodically transmit a buffer status report (BSR) to indicate an amount of data that is present at the buffer of the UE, among other information. Some aspects described herein enable enhanced buffer status reporting. For example, a UE may dynamically generate a buffer status report table based at least in part on a set of configured parameters (e.g., that a network node may signal to the UE).

### CROSS-REFERENCE TO RELATED APPLICATION

This patent application claims priority to U.S. Provisional Patent Application No. 63/481,377, filed on Jan. 24, 2023, entitled “BUFFER STATUS REPORTING MESSAGE,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for a buffer status reporting message.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

A user equipment (UE) may receive data, for transmission, at a buffer of the UE, such as when data is generated by an application of the UE. The UE may periodically transmit a buffer status report (BSR) to indicate an amount of data that is present at the buffer of the UE, among other information. The UE may report a total layer 2 (L2) buffer size of each logical control group (LCG) to a network node in a buffer status report medium access control (MAC) control element (CE) (MAC-CE). In some examples, the UE may encode the buffer size of each LCG using 5 bits or 8 bits based at least in part on a format of the MAC-CE that the UE is to use to transmit the buffer status report. For example, the UE may use a 5 bit indicator for a short-format BSR MAC-CE and an 8 bit indicator for a long-format BSR MAC-CE.

To encode the buffer size using a set of bits, the UE may use a buffer status report encoding table, which may have values associated with a formula:

$${B}_{k} = ⌈ {B}_{min} \cdot {( 1 + p )}^{k} ⌉ where p = {( {B}_{max} / {B}_{min} )}^{1 / ( N - 1 )} - 1$$

where Bₘᵢₙ is a minimum reported buffer size value, Bₘₐₓ is a maximum reported buffer size value, N is a quantity of encoding points (e.g., 32 for a 5 bit BSR and 256 for an 8 bit BSR), p is an error value, k is a step size, and Bₖ is a buffer size to report. Using the above-mentioned formula, the UE achieves an approximately constant error percentage p (e.g., (Bₖ₊₁−Bₖ)/Bₖ is approximately the same for all values of k), but can have a large absolute error for large values of k. For example, at k=252 and k=253, the UE is uses a step size of approximately 4,957,949 bytes. As a result, an absolute error (e.g., a difference between an actual buffer size when k=252 and a reported buffer size for k=252) may be substantial, which may result in an inefficient allocation of network resources to the UE to enable transmission of data in the buffer.

Some aspects described herein enable enhanced buffer status reporting. For example, a UE may dynamically generate a buffer status report table based at least in part on a set of configured parameters (e.g., that a network node may signal to the UE). Additionally, or alternatively, the UE may receive indication of a buffer status report table to use based at least in part on one or more parameters determined by a network node. In this way, the UE and/or the network node can minimize an absolute error in buffer size reporting, thereby enabling a more efficient allocation of network resources. For example, the UE may predict an expected size of a video frame in an extended reality (XR) application, and may use the expected size of the video frame to generate a BSR table for buffer size encoding and reporting. In this way, the UE may ensure a more efficient utilization of network resources for data-intensive applications, such as XR applications.

Some aspects described herein relate to a method of wireless communication performed by a UE. The method may include receiving, at a buffer, data for transmission. The method may include transmitting a buffer status report message regarding the data for transmission, the buffer status report message including an indication of the buffer, the indication of the buffer being encoded using a buffer status report table that is based at least in part on one or more parameter values.

Some aspects described herein relate to a method of wireless communication performed by a network node. The method may include receiving, from a UE, a buffer status report message regarding data, at a buffer of the UE, for transmission, the buffer status report message including an indication of the buffer, the indication of the buffer being encoded using a buffer status report table that is based at least in part on one or more parameter values. The method may include communicating with the UE based at least in part on a content of the buffer status report message.

Some aspects described herein relate to a UE for wireless communication. The UE may include a memory and one or more processors coupled to the memory. The one or more processors may be configured to receive, at a buffer, data for transmission. The one or more processors may be configured to transmit a buffer status report message regarding the data for transmission, the buffer status report message including an indication of the buffer, the indication of the buffer being encoded using a buffer status report table that is based at least in part on one or more parameter values.

Some aspects described herein relate to a network node for wireless communication. The network node may include a memory and one or more processors coupled to the memory. The one or more processors may be configured to receive, from a UE, a buffer status report message regarding data, at a buffer of the UE, for transmission, the buffer status report message including an indication of the buffer, the indication of the buffer being encoded using a buffer status report table that is based at least in part on one or more parameter values. The one or more processors may be configured to communicate with the UE based at least in part on a content of the buffer status report message.

Some aspects described herein relate to a non-transitory computer-readable medium that stores a set of instructions for wireless communication by an UE. The set of instructions, when executed by one or more processors of the UE, may cause the UE to receive, at a buffer, data for transmission. The set of instructions, when executed by one or more processors of the UE, may cause the UE to transmit a buffer status report message regarding the data for transmission, the buffer status report message including an indication of the buffer, the indication of the buffer being encoded using a buffer status report table that is based at least in part on one or more parameter values.

Some aspects described herein relate to a non-transitory computer-readable medium that stores a set of instructions for wireless communication by a network node. The set of instructions, when executed by one or more processors of the network node, may cause the network node to receive, from a UE, a buffer status report message regarding data, at a buffer of the UE, for transmission, the buffer status report message including an indication of the buffer, the indication of the buffer being encoded using a buffer status report table that is based at least in part on one or more parameter values. The set of instructions, when executed by one or more processors of the network node, may cause the network node to communicate with the UE based at least in part on a content of the buffer status report message.

Some aspects described herein relate to an apparatus for wireless communication. The apparatus may include means for receiving, at a buffer, data for transmission. The apparatus may include means for transmitting a buffer status report message regarding the data for transmission, the buffer status report message including an indication of the buffer, the indication of the buffer being encoded using a buffer status report table that is based at least in part on one or more parameter values.

Some aspects described herein relate to an apparatus for wireless communication. The apparatus may include means for receiving, from a UE, a buffer status report message regarding data, at a buffer of the UE, for transmission, the buffer status report message including an indication of the buffer, the indication of the buffer being encoded using a buffer status report table that is based at least in part on one or more parameter values. The apparatus may include means for communicating with the UE based at least in part on a content of the buffer status report message.

Aspects generally include a method, apparatus, system, computer program product, non-transitory computer-readable medium, user equipment, base station, wireless communication device, network entity, network node, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4D are diagrams illustrating an example associated with using a buffer status reporting message, in accordance with the present disclosure.

FIG. 5 is a flowchart of an example method of wireless communication, in accordance with the present disclosure.

FIG. 6 is a flowchart of an example method of wireless communication, in accordance with the present disclosure.

FIG. 7 is a diagram of an example apparatus for wireless communication, in accordance with the present disclosure.

FIG. 8 is a diagram illustrating an example of a hardware implementation for an apparatus employing a processing system, in accordance with the present disclosure.

FIG. 9 is a diagram of an example apparatus for wireless communication, in accordance with the present disclosure.

FIG. 10 is a diagram illustrating an example of a hardware implementation for an apparatus employing a processing system, in accordance with the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

A user equipment (UE) may receive data, for transmission, at a buffer of the UE, such as when data is generated by an application of the UE. The UE may periodically transmit a buffer status report (BSR) to indicate an amount of data that is present at the buffer of the UE, among other information. The UE may report a total layer 2 (L2) buffer size of each logical control group (LCG) to a network node in a buffer status report medium access control (MAC) control element (MAC-CE). In some examples, the UE may encode the buffer size of each LCG using 5 bits or 8 bits based at least in part on a format of the MAC-CE that the UE is to use to transmit the buffer status report. For example, the UE may use a 5 bit indicator for a short-format BSR MAC-CE and an 8 bit indicator for a long-format BSR MAC-CE.

To encode the buffer size using a set of bits, the UE may use a buffer status report encoding table, but using a fixed table can result in a large absolute error for large values of the fixed table. As a result, an absolute error (e.g., a difference between an actual buffer size and a reported buffer size) may be substantial, which may result in an inefficient allocation of network resources to the UE to enable transmission of data in the buffer.

Various aspects relate generally to enhanced buffer status reporting. Some aspects more specifically relate to a UE that may dynamically generate a buffer status report table based at least in part on a set of configured parameters (e.g., that a network node may signal to the UE). Additionally, or alternatively, the UE may receive indication of a buffer status report table to use based at least in part on one or more parameters determined by a network node. In some aspects, the UE may use a particular format of BSR MAC-CE to convey one or more fields associated with a BSR table that the UE can use for reporting a buffer size.

Particular aspects of the subject matter described in this disclosure can be implemented to realize one or more of the following potential advantages. In some examples, by using dynamically generated BSR tables, new statically configured BSR tables, or network-configured BSR tables, as described herein, the UE and/or a network node can minimize an absolute error in buffer size reporting, thereby enabling a more efficient allocation of network resources. In some examples, the UE may predict an expected size of a video frame in an extended reality (XR) application, and may use the expected size of the video frame to generate a BSR table for buffer size encoding and reporting. By generating a BSR table, the described techniques can be used to ensure a more efficient utilization of network resources for data-intensive applications, such as XR applications among other examples.

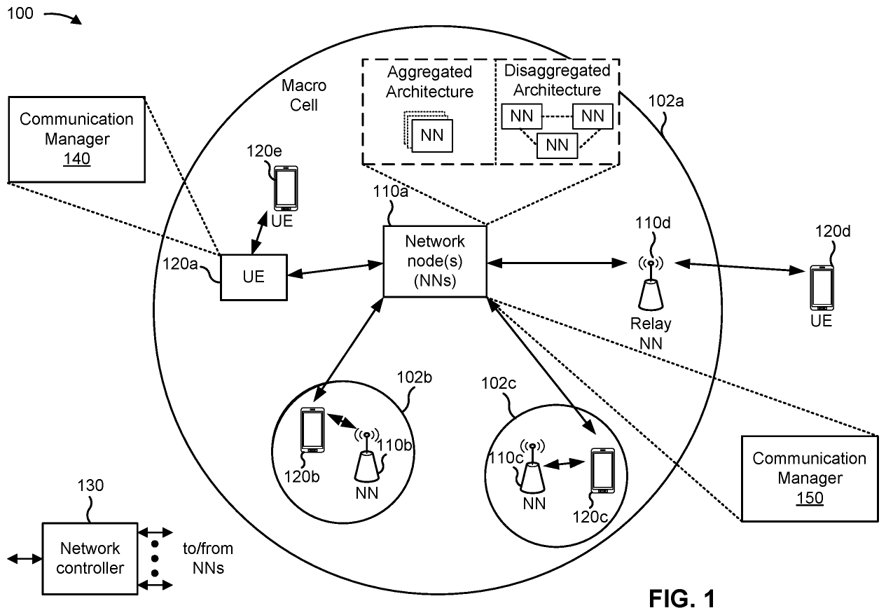

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an ENB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, at a buffer, data for transmission; and transmit a buffer status report message regarding the data for transmission, the buffer status report message including an indication of the buffer, the indication of the buffer being encoded using a buffer status report table that is based at least in part on one or more parameter values. Additionally, or alternatively, the communication manager 140 may perform one or more other operations described herein.

In some aspects, the network node 110 may include a communication manager 150. As described in more detail elsewhere herein, the communication manager 150 may receive, from a UE, a buffer status report message regarding data, at a buffer of the UE, for transmission, the buffer status report message including an indication of the buffer, the indication of the buffer being encoded using a buffer status report table that is based at least in part on one or more parameter values; communicate with the UE based at least in part on a content of the buffer status report message. Additionally, or alternatively, the communication manager 150 may perform one or more other operations described herein.

As indicated above, FIG. 1 is provided as an example. Other examples may differ from what is described with regard to FIG. 1.

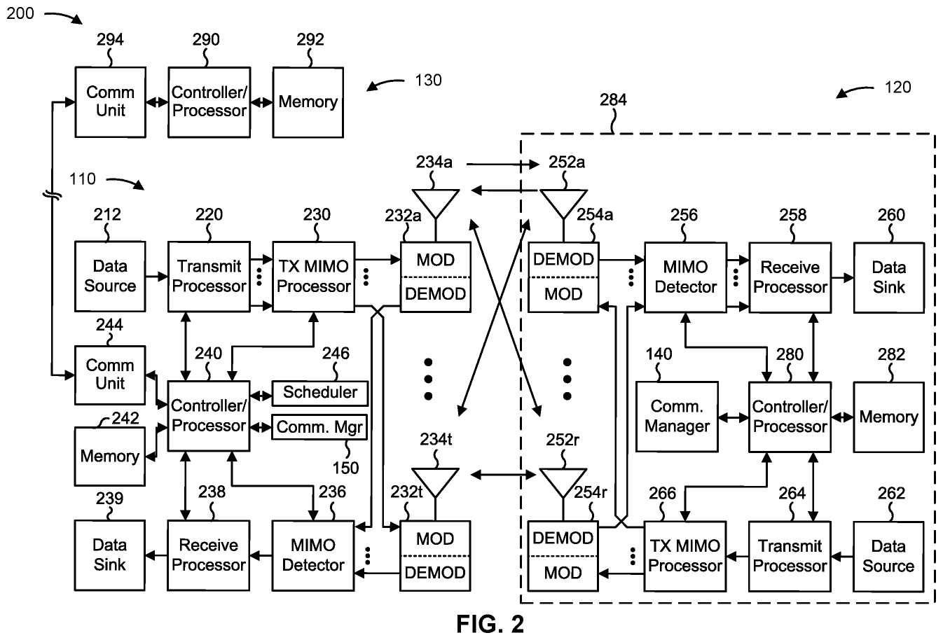

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

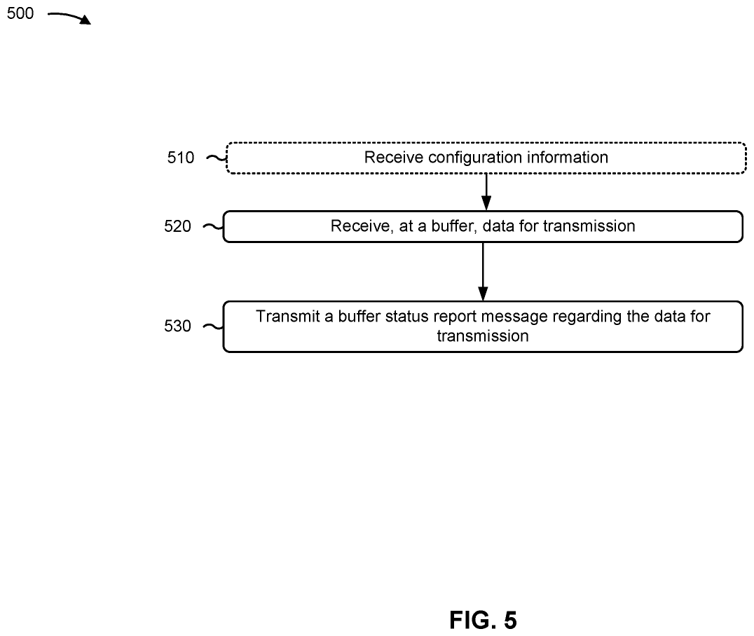

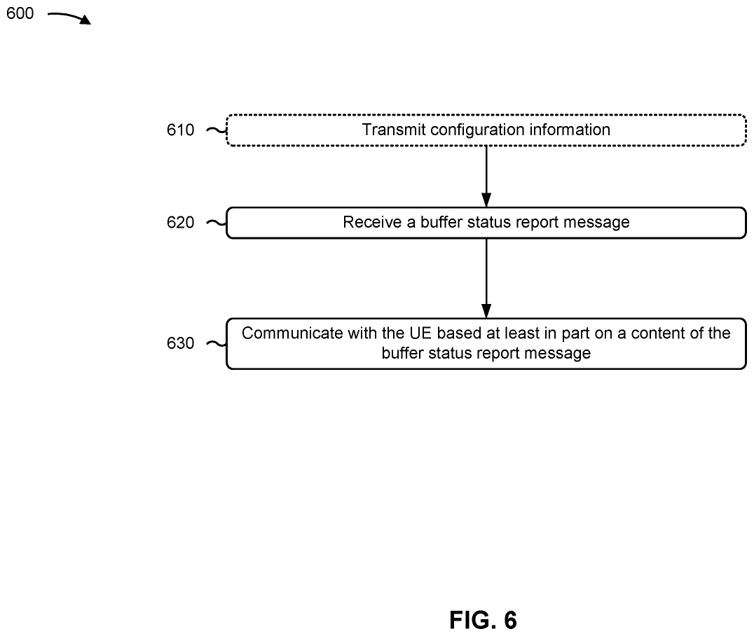

The controller/processor 240 of the network node 110, the controller/processor 280 of the UE 120, and/or any other component(s) of FIG. 2 may perform one or more techniques associated with buffer status reporting, as described in more detail elsewhere herein. For example, the controller/processor 240 of the network node 110, the controller/processor 280 of the UE 120, and/or any other component(s) of FIG. 2 may perform or direct operations of, for example, method 500 of FIG. 5, method 600 of FIG. 6, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, method 500 of FIG. 5, method 600 of FIG. 6, and/or other processes as described herein. In some examples, executing instructions may include running the instructions, converting the instructions, compiling the instructions, and/or interpreting the instructions, among other examples.

In some aspects, the UE 120 includes means for receiving, at a buffer, data for transmission; and/or means for transmitting a buffer status report message regarding the data for transmission, the buffer status report message including an indication of the buffer, the indication of the buffer being encoded using a buffer status report table that is based at least in part on one or more parameter values. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE, a buffer status report message regarding data, at a buffer of the UE, for transmission, the buffer status report message including an indication of the buffer, the indication of the buffer being encoded using a buffer status report table that is based at least in part on one or more parameter values; means for communicating with the UE based at least in part on a content of the buffer status report message. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

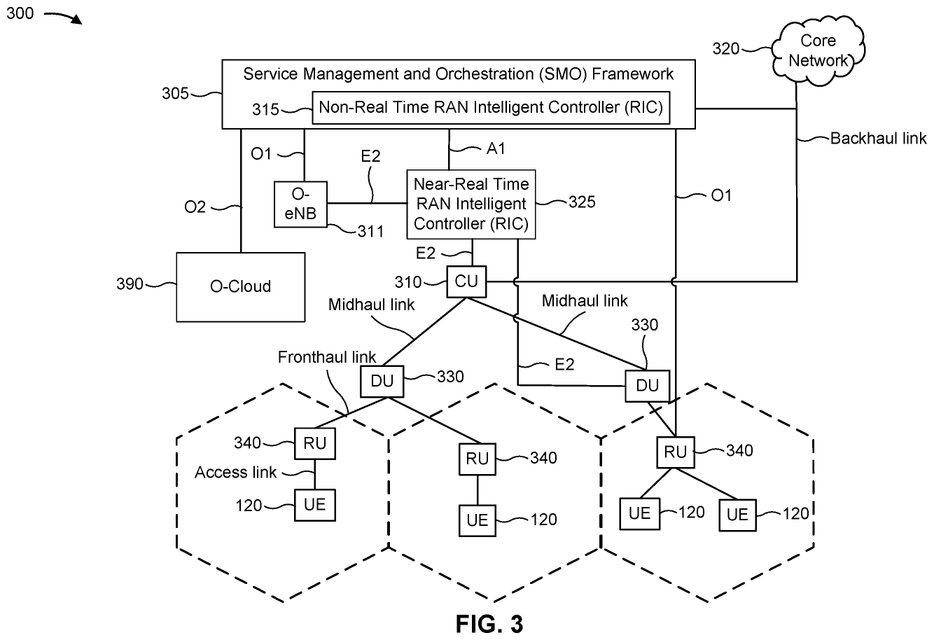

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A UE may receive data, for transmission, at a buffer of the UE, such as when data is generated by an application of the UE. The UE may periodically transmit a buffer status report (BSR) to indicate an amount of data that is present at the buffer of the UE, among other information. The UE may report a total layer 2 (L2) buffer size of each logical control group (LCG) to a network node in a buffer status report MAC control element (CE) (MAC-CE). In some examples, the UE may encode the buffer size of each LCG using 5 bits or 8 bits based at least in part on a format of the MAC-CE that the UE is to use to transmit the buffer status report. For example, the UE may use a 5 bit indicator for a short-format BSR MAC-CE and an 8 bit indicator for a long-format BSR MAC-CE.

To encode the buffer size using a set of bits, the UE may use a buffer status report encoding table, but using a fixed table can result in a large absolute error for large values of the fixed table. As a result, an absolute error (e.g., a difference between an actual buffer size and a reported buffer size) may be substantial, which may result in an inefficient allocation of network resources to the UE to enable transmission of data in the buffer.

Some aspects described herein enable enhanced buffer status reporting. For example, a UE may dynamically generate a buffer status report table based at least in part on a set of configured parameters (e.g., that a network node may signal to the UE). Additionally, or alternatively, the UE may receive indication of a buffer status report table to use based at least in part on one or more parameters determined by a network node. In this way, the UE and/or the network node can minimize an absolute error in buffer size reporting, thereby enabling a more efficient allocation of network resources. For example, the UE may predict an expected size of a video frame in an extended reality (XR) application, and may use the expected size of the video frame to generate a BSR table for buffer size encoding and reporting. In this way, the UE may ensure a more efficient utilization of network resources for data-intensive applications, such as XR applications.

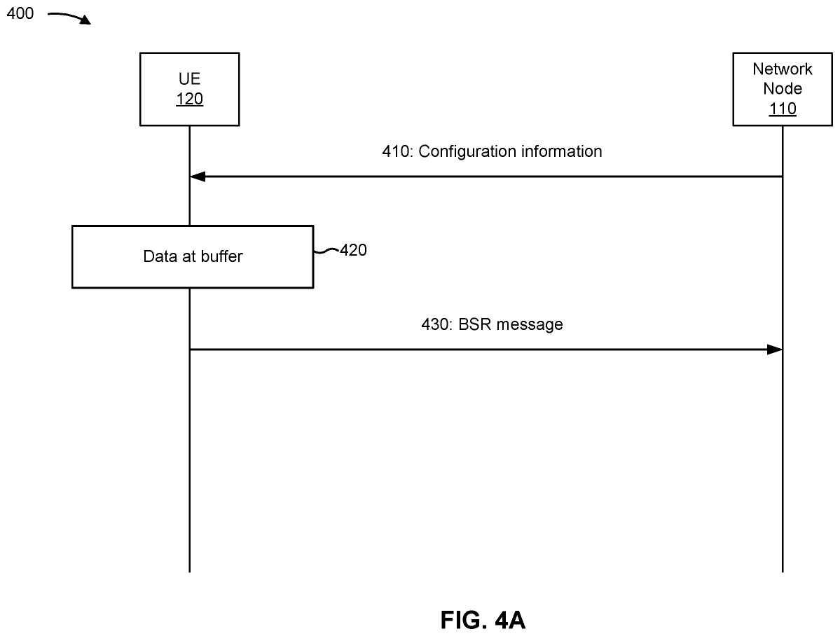

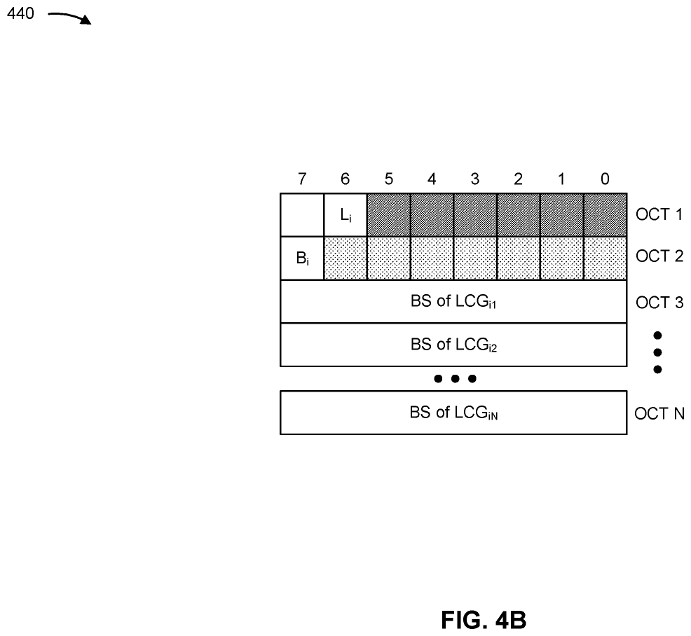

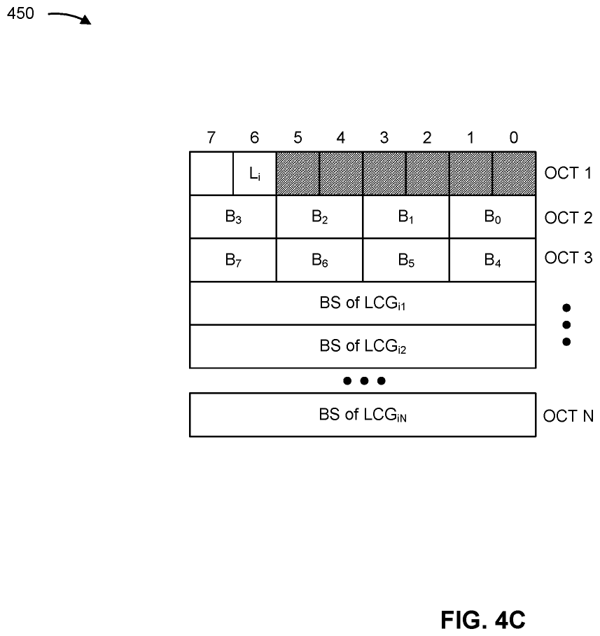

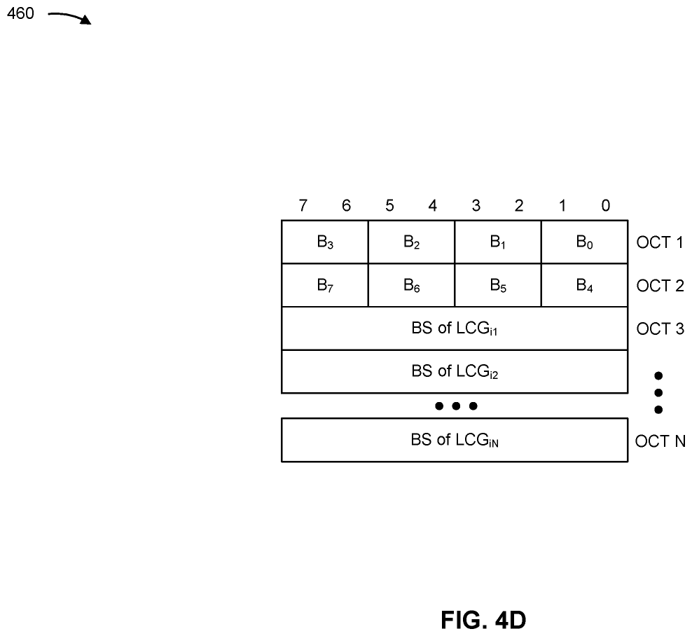

FIGS. 4A-4D are diagrams illustrating an example 400 associated with using a buffer status reporting message, in accordance with the present disclosure. As shown in FIG. 4, example 400 includes communication between a network node 110 and a UE 120.

As shown in FIG. 4A, and by reference number 410, the UE 120 may receive configuration information. For example, the UE 120 may receive configuration information associated with configuring a buffer status report. In some aspects, the UE 120 may receive configuration information associated with dynamically generating a buffer status report table. For example, the UE 120 may receive information associated with identifying one or more parameters, such as a minimum reported buffer status value Bₘᵢₙ, a maximum reported buffer status value Bₘₐₓ, an encoding error value p, or a quantity of encoding points for the buffer status report N, among other examples. In this case, as particular examples, the network node 110 may transmit information identifying Bₘᵢₙ, Bₘₐₓ, information identifying Bₘᵢₙ, Bₘₐₓ, and N, or information identifying Bₘᵢₙ, Bₘₐₓ, P, and N, among other examples of combinations. Based at least in part on receiving the set of parameters, the UE 120 may dynamically generate a buffer status report table (or other data structure) from which to select a value for a buffer status report. In other words, the UE 120 may generate a buffer status report table for encoding a buffer status report in connection with a buffer size encoding equation with Bₘᵢₙ as a minimum value, Bₘₐₓ as a maximum value, N as a quantity of values between Bₘᵢₙ and Bₘₐₓ. In this case, the buffer size encoding equation configured for the UE 120 may be:

$${B}_{k} = ⌈ {B}_{min} \cdot {( 1 + p )}^{k} ⌉ where p = {( {B}_{max} / {B}_{min} )}^{1 / ( N - 1 )} - 1$$

where p is the encoding error value parameter, as described above.

In some aspects, the UE 120 may receive the information identifying the one or more parameters via a type of signaling. For example, the network node 110 may broadcast information identifying the parameters via a system information transmission, such as a system information block (SIB) transmission. Additionally, or alternatively, the network node 110 may transmit dedicated signaling identifying the parameters, such as radio resource control (RRC) signaling, downlink control information (DCI) signaling, or medium access control (MAC) control element (CE) (MAC-CE) signaling. In some aspects, the UE 120 may set a prohibit timer associated with the dedicated signaling. For example, when the UE 120 receives first signaling identifying a set of parameters, the UE 120 may set the prohibit timer for a configured length of time (e.g., which may be configured in a specification or by network node signaling). In this case, if the UE 120 receives second signaling identifying a new set of parameters before the prohibit timer expires, the UE 120 may disregard the new set of parameters and may continue using the set of parameters signaled using the first signaling.

In some aspects, the UE 120 may receive information identifying a buffer status report table. For example, the UE 120 may be configured, in accordance with a specification, with a plurality of BSR tables corresponding to different combinations of possible parameter values for Bₘᵢₙ, Bₘₐₓ, N, and/or p. In this case, possible values for the parameters may be associated with a data type. For example, when the buffer of the UE 120 is associated with conveying video frames for an extended reality (XR) application, the UE 120 may be configured with a plurality of BSR tables corresponding to possible parameter values for a video frame size, encoding rate, or resolution of the XR application. In this case, the UE 120 may receive configuration information associated with indicating a selection of a BSR table or indicating that the UE 120 is to use a configured BSR table. In some aspects, the UE 120 may be configured with a parameter representing a maximum quantity of possible step sizes for BSR tables and/or a maximum quantity of BSR tables that the UE 120 can be configured with.

In some aspects, the UE 120 may receive configuration information indicating a per-logical-control-group (LCG) BSR table selection. For example, the network node 110 may configure an LCG with a plurality of BSR tables that do not include overlapping ranges. Accordingly, the UE 120, as part of the LCG, may use a configured BSR table associated with the LCG or a legacy BSR table (e.g., that is not configured on a per-LCG basis). For example, when an LCG has a buffer size that is within a range of a configured per-LCG BSR table, the UE 120 may use the associated per-LCG BSR table. Alternatively, when the LCG has a buffer size that is not within a range of any configured per-LCG BSR table, the UE 120 may use a legacy BSR table (e.g., that is not configured on a per-LCG basis).

In some aspects, the UE 120 may receive configuration information explicitly identifying a BSR table to use to report a buffer size for an LCG. For example, the UE 120 may receive a BSR MAC CE with an indicator of a BSR table of a plurality of configured BSR tables. In some aspects, if an LCG buffer size is within a range of a plurality of BSR tables, the UE 120 may select a particular BSR table with a smallest step size. In some aspects, the UE 120 may select a BSR table based at least in part on an uplink grant size. For example, when an uplink grant includes an amount of network resources to use a BSR MAC CE that is configured for, for example, non-legacy BSR tables, such as per-LCG BSR tables, the UE 120 may select a non-legacy BSR table for BSR reporting of a non-legacy (e.g., enhanced) BSR MAC-CE. Alternatively, when the uplink grant is not large enough to include an indication associated with a non-legacy BSR table, the UE 120 may use a legacy BSR table and transmit a legacy BSR MAC-CE.

As further shown in FIG. 4A, and by reference number 420, the UE 120 may receive data for transmission. For example, the UE 120 may have a buffer for transmitting data (e.g., control data or payload data) and may identify that the buffer includes data that is to be transmitted. In some aspects, the UE 120 may generate the data. For example, an application of the UE 120 may generate data and provide the data (or an indication of the data) to the buffer, which may indicate to the UE 120 that the UE 120 is to transmit the data.

As further shown in FIG. 4A, and by reference number 430, the UE 120 may transmit a BSR message. For example, the UE 120 may transmit a BSR MAC-CE to the network node 110 to indicate a status of data for transmission at a buffer of the UE 120. In some aspects, the UE 120 may transmit a BSR MAC-CE with a first format. For example, as shown in FIG. 4B, and by reference number 440, the BSR MAC-CE may include an LCG bitmap Lₘ, which indicates whether the corresponding LCG (LCGₘ) includes buffered data, such as LCG bitmap Lᵢ of the first octet. Additionally, or alternatively, the first format of the BSR MAC-CE may include a BSR table bitmap Tₘ, which may indicate whether a legacy BSR table or an enhanced BSR table is being used for reporting LCGₘ, such as the BSR table bitmap Bᵢ of the second octet. Additionally, or alternatively, the first format of the BSR MAC-CE may include a buffer size indicator for an LCG, which may indicate a size of a buffer (e.g., an amount of data) for LCGₘ, as shown in the third through nth octets. In some aspects, the UE 120 may use the first format when the UE 120 is configured by the network node 110 with BSR tables without overlapping ranges and can determine to use an enhanced BSR table or a legacy BSR table, as described above.

Additionally, or alternatively, as shown in FIG. 4C, and by reference number 450, the UE 120 may transmit a BSR MAC-CE with a second format. In the second format, the BSR MAC-CE may include the LCG bitmap indicator Lₘ and an index value identifying a BSR table Bₘ. For example, each LCG for which a buffer status is reported, in up to the nth octet, may have a corresponding Bᵢ in octets 2 and 3 that identifies a BSR table that was used to generate the buffer status being reported. In some aspects, the UE 120 may use the second format when the UE 120 is configured to indicate which BSR table is being used to report a buffer size for an LCG, as described above.

Additionally, or alternatively, as shown in FIG. 4D, and by reference number 460, the UE 120 may transmit a BSR MAC-CE with a third format. In the third format, the UE 120 may include a BSR table index value Bₘ for an LCGₘ, but may omit the LCG bitmap Lₘ as is used in the first format and the second format. In this case, when the value of the BSR table index corresponding to LCGₘ is 0 (or another configured value), the network node 110 may interpret the BSR table index as indicating that LCGₘ has no buffered data for reporting of a buffer size. Alternatively, the value of the field for LCGₘ indicates an index of a BSR table which is being used to report the LCGₘ. In some aspects, the UE 120 may use the second format when the UE 120 is configured to indicate which BSR table is being used to report a buffer size for an LCG, as described above.

As indicated above, FIGS. 4A-4D are provided as examples. Other examples may differ from what is described with respect to FIGS. 4A-4D.

FIG. 5 is a flowchart of an example method 500 of wireless communication. The method 500 may be performed by, for example, a UE (e.g., UE 120).

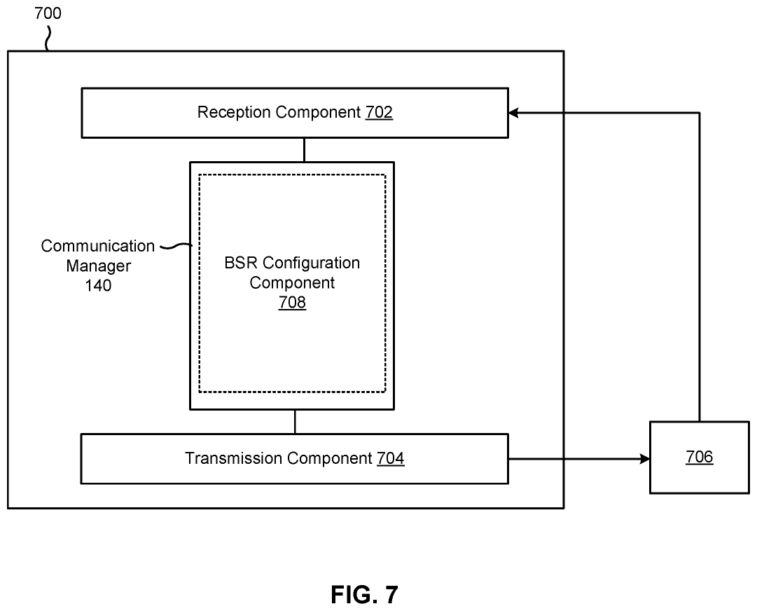

At 510, in some aspects, the UE may receive configuration information. For example, the UE (e.g., using communication manager 140 and/or reception component 702, depicted in FIG. 7) may receive signaling identifying the one or more parameter values via a system information transmission or a dedicated signaling transmission, as described above. Additionally, or alternatively, the UE (e.g., using communication manager 140 and/or reception component 702, depicted in FIG. 7) may receive configuration information associated with configuring the buffer status report table, wherein the configuration information is on a per logical channel group basis.

In some aspects, the one or more parameter values includes at least one of a minimum reported buffer status value, a maximum reported buffer status value, an encoding error value, or a quantity of encoding points for the buffer status report message. In some aspects, the one or more parameter values are selected from a set of possible parameter values based at least in part on at least one of a predicted data size, a resolution, or an encoding rate. In some aspects, the buffer status report table is based at least in part on one or more static parameters, the one or more static parameters including at least one of a maximum quantity of step sizes or a maximum quantity of buffer status report tables. In some aspects, the configuration information configures the buffer status report table for a logical channel group such that a range of the buffer status report table does not overlap with any other range of any other buffer status report table for the logical channel group.

In some aspects, the buffer status report message includes information identifying the buffer status report table. For example, the buffer status report message may include a bitmap with a set of values identifying the buffer status report table. Additionally, or alternatively, the buffer status report message may include a bitmap with a set of values identifying a type of buffer status report table. For example, the bitmap may include a first value to indicate a first type of buffer status report table (e.g., a legacy buffer status report table) and a second value to indicate a second type of buffer status report table (e.g., an enhanced or new buffer status report table).

At 520, the UE may receive, at a buffer, data for transmission. For example, the UE (e.g., using communication manager 140 and/or reception component 702, depicted in FIG. 7) may receive, at a buffer, data for transmission, as described above. In some aspects, the UE is triggered to transmit a buffer status report message to report the data received at the buffer for transmission. In some aspects, the UE may select the buffer status report table from a set of available buffer status report tables based at least in part on a characteristic of the buffer.

At 530, the UE may transmit a buffer status report message. For example, the UE (e.g., using communication manager 140 and/or transmission component 704, depicted in FIG. 7) may transmit a buffer status report message regarding the data for transmission, as described above. In some aspects, the buffer status report message may include an indication of the buffer, the indication of the buffer being encoded using a buffer status report table that is based at least in part on one or more parameter values. In some aspects, the buffer status report message is a MAC-CE including at least one of a logical channel control group indicator, a logical channel control group queue indicator, a buffer status report table indicator, or a buffer size indicator.

Although FIG. 5 shows example blocks of method 500, in some aspects, method 500 may include additional blocks, fewer blocks, different blocks, or differently arranged blocks than those depicted in FIG. 5. Additionally, or alternatively, two or more of the blocks of method 500 may be performed in parallel.

FIG. 6 is a flowchart of an example method 600 of wireless communication. The method 600 may be performed by, for example, a network node (e.g., network node 110).

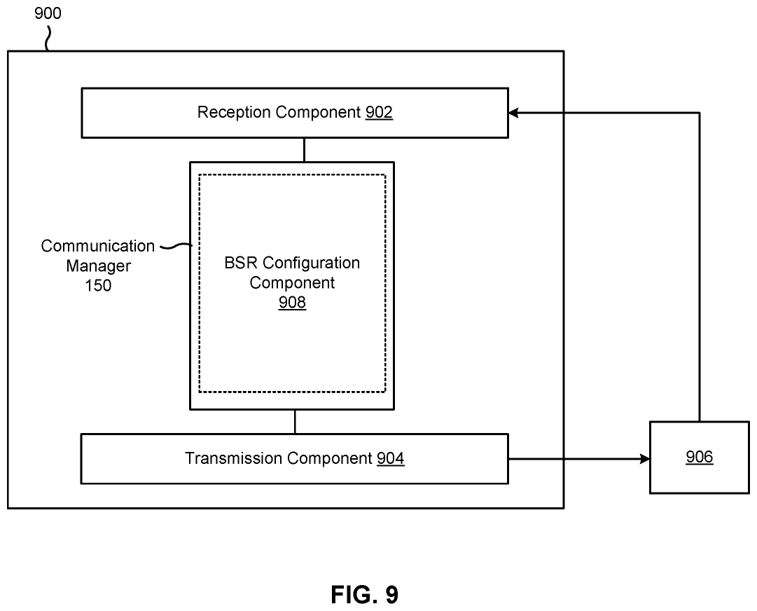

At 610, in some aspects, the network node may transmit configuration information. For example, the network node (e.g., using communication manager 150 and/or transmission component 904, depicted in FIG. 9) may transmit configuration information, as described above.

In some aspects, the network node may transmit signaling identifying the one or more parameter values via a system information transmission or a dedicated signaling transmission. In some aspects, the one or more parameter values includes at least one of a minimum reported buffer status value, a maximum reported buffer status value, an encoding error value, or a quantity of encoding points for the buffer status report message. In some aspects, the one or more parameter values are based at least in part on at least one of a predicted data size, a resolution, or an encoding rate.

In some aspects, the network node is configured to transmit configuration information associated with configuring the buffer status report table, wherein the configuration information is on a per logical channel group basis. In some aspects, the buffer status report table is based at least in part on one or more static parameters, the one or more static parameters including at least one of a maximum quantity of step sizes or a maximum quantity of buffer status report tables. In some aspects, the configuration information configures the buffer status report table for a logical channel group such that a range of the buffer status report table does not overlap with any other range of any other buffer status report table for the logical channel group. In some aspects, the network node may configure the UE to select the buffer status report table from a set of available buffer status report tables based at least in part on a characteristic of the buffer.

At 620, the network node may receive a buffer status report message. For example, the network node (e.g., using communication manager 150 and/or reception component 902, depicted in FIG. 9) may receive, from a UE, a buffer status report message regarding data, at a buffer of the UE, for transmission, as described above. In some aspects, the buffer status report message may include an indication of the buffer. In some aspects, the indication of the buffer may be encoded using a buffer status report table that is based at least in part on one or more parameter values. In some aspects, the buffer status report message includes information identifying the buffer status report table. For example, the buffer status report message may include a bitmap with a set of values identifying the buffer status report table. Additionally, or alternatively, the buffer status report message may include a bitmap with a set of values identifying a type of buffer status report table. For example, the bitmap may include a first value to indicate a first type of buffer status report table (e.g., a legacy buffer status report table) and a second value to indicate a second type of buffer status report table (e.g., an enhanced or new buffer status report table). In some aspects, the buffer status report message is a MAC control element including at least one of a logical channel control group indicator, a logical channel control group queue indicator, a buffer status report table indicator, or a buffer size indicator.

At 630, the network node may communicate with the UE based at least in part on a content of the buffer status report message. For example, the network node (e.g., using communication manager 150, reception component 902, and/or transmission component 904, depicted in FIG. 9) may communicate with the UE based at least in part on a content of the buffer status report message, as described above. In some aspects, the network node may schedule resources for the UE to transmit the data on the buffer based at least in part on the content of the buffer status report message. In some aspects, the network node may receive a transmission of the data on the buffer.

Although FIG. 6 shows example blocks of method 600, in some aspects, method 600 may include additional blocks, fewer blocks, different blocks, or differently arranged blocks than those depicted in FIG. 6. Additionally, or alternatively, two or more of the blocks of method 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include one or more of a BSR configuration component 708, among other examples.

In some aspects, the apparatus 700 may be configured to perform one or more operations described herein. Additionally, or alternatively, the apparatus 700 may be configured to perform one or more processes described herein, such as method 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive, at a buffer, data for transmission. The transmission component 704 may transmit a buffer status report message regarding the data for transmission, the buffer status report message including an indication of the buffer, the indication of the buffer being encoded using a buffer status report table that is based at least in part on one or more parameter values.

The reception component 702 may receive signaling identifying the one or more parameter values via a system information transmission or a dedicated signaling transmission. The reception component 702 may receive configuration information associated with configuring the buffer status report table, wherein the configuration information is on a per logical channel group basis. The BSR configuration component 708 may generate or select a BSR table to use for encoding BSR information in a BSR message.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

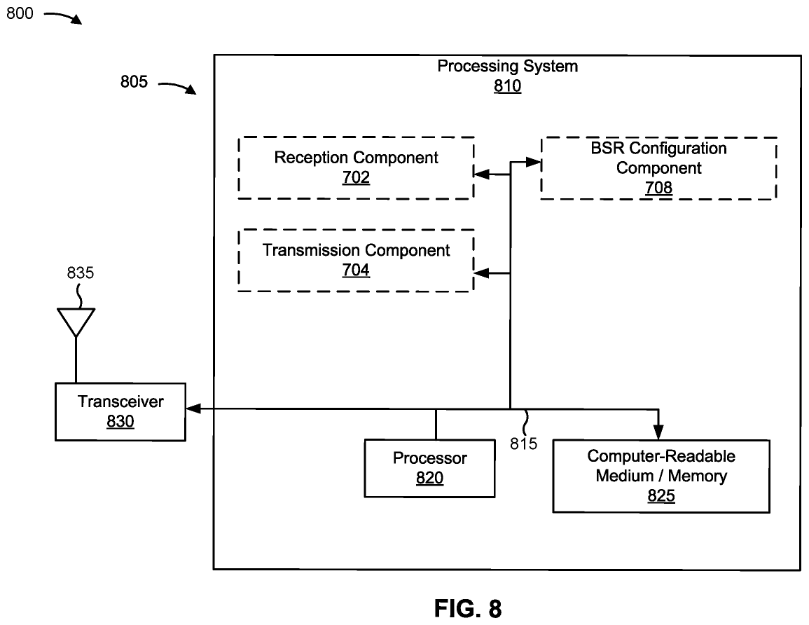

FIG. 8 is a diagram illustrating an example 800 of a hardware implementation for an apparatus 805 employing a processing system 810, in accordance with the present disclosure. The apparatus 805 may be a UE.

The processing system 810 may be implemented with a bus architecture, represented generally by the bus 815. The bus 815 may include any number of interconnecting buses and bridges depending on the specific application of the processing system 810 and the overall design constraints. The bus 815 links together various circuits including one or more processors and/or hardware components, represented by the processor 820, the illustrated components, and the computer-readable medium/memory 825. The bus 815 may also link various other circuits, such as timing sources, peripherals, voltage regulators, and/or power management circuits.

The processing system 810 may be coupled to a transceiver 830. The transceiver 830 is coupled to one or more antennas 835. The transceiver 830 provides a means for communicating with various other apparatuses over a transmission medium. The transceiver 830 receives a signal from the one or more antennas 835, extracts information from the received signal, and provides the extracted information to the processing system 810, specifically the reception component 702. In addition, the transceiver 830 receives information from the processing system 810, specifically the transmission component 704, and generates a signal to be applied to the one or more antennas 835 based at least in part on the received information.

The processing system 810 includes a processor 820 coupled to a computer-readable medium/memory 825. The processor 820 is responsible for general processing, including the execution of software stored on the computer-readable medium/memory 825. The software, when executed by the processor 820, causes the processing system 810 to perform the various functions described herein for any particular apparatus. The computer-readable medium/memory 825 may also be used for storing data that is manipulated by the processor 820 when executing software. The processing system further includes at least one of the illustrated components. The components may be software modules running in the processor 820, resident/stored in the computer readable medium/memory 825, one or more hardware modules coupled to the processor 820, or some combination thereof.

In some aspects, the processing system 810 may be a component of the UE 120 and may include the memory 282 and/or at least one of the TX MIMO processor 266, the receive (RX) processor 258, and/or the controller/processor 280. In some aspects, the apparatus 805 for wireless communication includes means for receiving, at a buffer, data for transmission; and/or means for transmitting a buffer status report message regarding the data for transmission, the buffer status report message including an indication of the buffer, the indication of the buffer being encoded using a buffer status report table that is based at least in part on one or more parameter values. The aforementioned means may be one or more of the aforementioned components of the apparatus 700 and/or the processing system 810 of the apparatus 805 configured to perform the functions recited by the aforementioned means. As described elsewhere herein, the processing system 810 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 8 is provided as an example. Other examples may differ from what is described in connection with FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a BSR configuration component 908, among other examples.

In some aspects, the apparatus 900 may be configured to perform one or more operations described herein. Additionally, or alternatively, the apparatus 900 may be configured to perform one or more processes described herein, such as method 600 of FIG. 6. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The reception component 902 may receive, from a UE, a buffer status report message regarding data, at a buffer of the UE, for transmission, the buffer status report message including an indication of the buffer, the indication of the buffer being encoded using a buffer status report table that is based at least in part on one or more parameter values. The reception component 902 and/or the transmission component 904 may communicate with the UE based at least in part on a content of the buffer status report message.

The transmission component 904 may transmit signaling identifying the one or more parameter values via a system information transmission or a dedicated signaling transmission. The transmission component 904 may transmit configuration information associated with configuring the buffer status report table, wherein the configuration information is on a per logical channel group basis. The BSR configuration component 908 may configure or determine a set of parameters from which a UE can select or generate a BSR table. The BSR configuration component 908 may select a BSR table for a UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

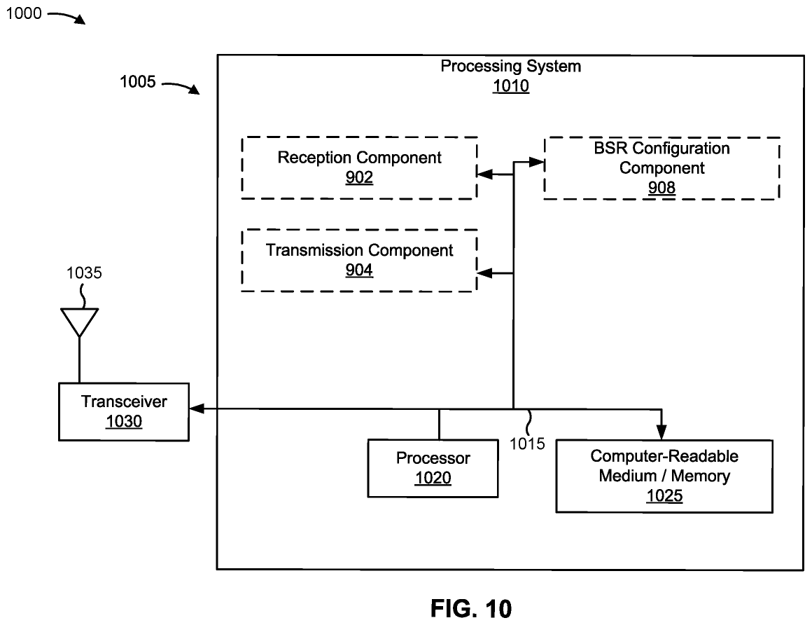

FIG. 10 is a diagram illustrating an example 1000 of a hardware implementation for an apparatus 1005 employing a processing system 1010, in accordance with the present disclosure. The apparatus 1005 may be a network node.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by the processor 1020, the illustrated components, and the computer-readable medium/memory 1025. The bus 1015 may also link various other circuits, such as timing sources, peripherals, voltage regulators, and/or power management circuits.

The processing system 1010 may be coupled to a transceiver 1030. The transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 902. In addition, the transceiver 1030 receives information from the processing system 1010, specifically the transmission component 904, and generates a signal to be applied to the one or more antennas 1035 based at least in part on the received information.

The processing system 1010 includes a processor 1020 coupled to a computer-readable medium/memory 1025. The processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the network node 110 and may include the memory 242 and/or at least one of the TX MIMO processor 230, the RX processor 238, and/or the controller/processor 240. In some aspects, the apparatus 1005 for wireless communication includes means for receiving, from a UE, a buffer status report message regarding data, at a buffer of the UE, for transmission, the buffer status report message including an indication of the buffer, the indication of the buffer being encoded using a buffer status report table that is based at least in part on one or more parameter values; and/or means for communicating with the UE based at least in part on a content of the buffer status report message. The aforementioned means may be one or more of the aforementioned components of the apparatus 900 and/or the processing system 1010 of the apparatus 1005 configured to perform the functions recited by the aforementioned means. As described elsewhere herein, the processing system 1010 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 10 is provided as an example. Other examples may differ from what is described in connection with FIG. 10.

The following provides an overview of some Aspects of the present disclosure:
Aspect 1: A method of wireless communication performed by a user equipment (UE), comprising: receiving, at a buffer, data for transmission; and transmitting a buffer status report message regarding the data for transmission, the buffer status report message including an indication of the buffer, the indication of the buffer being encoded using a buffer status report table that is based at least in part on one or more parameter values.
Aspect 2: The method of Aspect 1, further comprising: receiving signaling identifying the one or more parameter values via a system information transmission or a dedicated signaling transmission.
Aspect 3: The method of any of Aspects 1-2, wherein the one or more parameter values includes at least one of: a minimum reported buffer status value, a maximum reported buffer status value, an encoding error value, or a quantity of encoding points for the buffer status report message.
Aspect 4: The method of any of Aspects 1-3, wherein the one or more parameter values are selected from a set of possible parameter values based at least in part on at least one of a predicted data size, a resolution, or an encoding rate.
Aspect 5: The method of any of Aspects 1-4, wherein the buffer status report table is based at least in part on one or more static parameters, the one or more static parameters including at least one of a maximum quantity of step sizes or a maximum quantity of buffer status report tables.
Aspect 6: The method of any of Aspects 1-5, further comprising: receiving configuration information associated with configuring the buffer status report table, wherein the configuration information is on a per logical channel group basis.
Aspect 7: The method of Aspect 6, wherein the configuration information configures the buffer status report table for a logical channel group such that a range of the buffer status report table does not overlap with any other range of any other buffer status report table for the logical channel group.
Aspect 8: The method of any of Aspects 1-7, wherein the buffer status report message includes information identifying the buffer status report table.
Aspect 9: The method of any of Aspects 1-8, wherein the buffer status report message is a medium access control (MAC) control element including at least one of: a logical channel control group indicator, a logical channel control group queue indicator, a buffer status report table indicator, or a buffer size indicator.
Aspect 10: The method of any of Aspects 1-9, wherein information identifying the buffer status report table includes a bitmap.
Aspect 11: A method of wireless communication performed by a network node, comprising: receiving, from a user equipment (UE), a buffer status report message regarding data, at a buffer of the UE, for transmission, the buffer status report message including an indication of the buffer, the indication of the buffer being encoded using a buffer status report table that is based at least in part on one or more parameter values; communicating with the UE based at least in part on a content of the buffer status report message.
Aspect 12: The method of Aspect 11, further comprising: transmitting signaling identifying the one or more parameter values via a system information transmission or a dedicated signaling transmission.
Aspect 13: The method of any of Aspects 11-12, wherein the one or more parameter values includes at least one of: a minimum reported buffer status value, a maximum reported buffer status value, an encoding error value, or a quantity of encoding points for the buffer status report message.
Aspect 14: The method of any of Aspects 11-13, wherein the one or more parameter values are based at least in part on at least one of a predicted data size, a resolution, or an encoding rate.
Aspect 15: The method of any of Aspects 11-14, wherein the buffer status report table is based at least in part on one or more static parameters, the one or more static parameters including at least one of a maximum quantity of step sizes or a maximum quantity of buffer status report tables.
Aspect 16: The method of any of Aspects 11-15, further comprising: transmitting configuration information associated with configuring the buffer status report table, wherein the configuration information is on a per logical channel group basis.
Aspect 17: The method of Aspect 16, wherein the configuration information configures the buffer status report table for a logical channel group such that a range of the buffer status report table does not overlap with any other range of any other buffer status report table for the logical channel group.
Aspect 18: The method of any of Aspects 11-17, wherein the buffer status report message includes information identifying the buffer status report table.
Aspect 19: The method of any of Aspects 11-18, wherein the buffer status report message is a medium access control (MAC) control element including at least one of: a logical channel control group indicator, a logical channel control group queue indicator, a buffer status report table indicator, or a buffer size indicator.
Aspect 20: The method of any of Aspects 11-19, wherein information identifying the buffer status report table includes a bitmap.
Aspect 21: An apparatus for wireless communication at a device, comprising a processor; memory coupled with the processor; and instructions stored in the memory and executable by the processor to cause the apparatus to perform the method of one or more of Aspects 1-20.
Aspect 22: A device for wireless communication, comprising a memory and one or more processors coupled to the memory, the one or more processors configured to perform the method of one or more of Aspects 1-20.
Aspect 23: An apparatus for wireless communication, comprising at least one means for performing the method of one or more of Aspects 1-20.
Aspect 24: A non-transitory computer-readable medium storing code for wireless communication, the code comprising instructions executable by a processor to perform the method of one or more of Aspects 1-20.
Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, at a buffer, data for transmission; and
transmit a buffer status report message regarding the data for transmission, the buffer status report message including an indication of the buffer, the indication of the buffer being encoded using a buffer status report table that is based at least in part on one or more parameter values.

2. The UE of claim 1, wherein the buffer status report message includes information identifying the buffer status report table.

3. The UE of claim 2, wherein the information identifying the buffer status report table includes a bitmap.

4. The UE of claim 1, wherein the one or more processors are further configured to:
receive signaling identifying the one or more parameter values via a system information transmission or a dedicated signaling transmission.

5. The UE of claim 1, wherein the one or more parameter values includes at least one of:
a minimum reported buffer status value,
a maximum reported buffer status value,
an encoding error value, or
a quantity of encoding points for the buffer status report message.

6. The UE of claim 1, wherein the one or more parameter values are selected from a set of possible parameter values based at least in part on at least one of a predicted data size, a resolution, or an encoding rate.

7. The UE of claim 1, wherein the buffer status report table is based at least in part on one or more static parameters, the one or more static parameters including at least one of a maximum quantity of step sizes or a maximum quantity of buffer status report tables.

8. The UE of claim 1, wherein the one or more processors are further configured to:
receive configuration information associated with configuring the buffer status report table, wherein the configuration information is on a per logical channel group basis.

9. The UE of claim 8, wherein the configuration information configures the buffer status report table for a logical channel group such that a range of the buffer status report table does not overlap with any other range of any other buffer status report table for the logical channel group.

10. The UE of claim 1, wherein the buffer status report message is a medium access control (MAC) control element including at least one of:
a logical channel control group indicator,
a logical channel control group queue indicator,
a buffer status report table indicator, or
a buffer size indicator.

11. The UE of claim 1, wherein the UE is configured to select the buffer status report table from a set of available buffer status report tables based at least in part on a characteristic of the buffer.

12. A network node for wireless communication, comprising:
a memory; and
one or more processors, coupled to the memory, configured to:
receive, from a user equipment (UE), a buffer status report message regarding data, at a buffer of the UE, for transmission, the buffer status report message including an indication of the buffer, the indication of the buffer being encoded using a buffer status report table that is based at least in part on one or more parameter values; and
communicate with the UE based at least in part on a content of the buffer status report message.

13. The network node of claim 12, wherein the buffer status report message includes information identifying the buffer status report table.

14. The network node of claim 13, wherein the information identifying the buffer status report table includes a bitmap.

15. The network node of claim 12, wherein the one or more processors are further configured to:
transmit signaling identifying the one or more parameter values via a system information transmission or a dedicated signaling transmission.

16. The network node of claim 12, wherein the one or more parameter values includes at least one of:
a minimum reported buffer status value,
a maximum reported buffer status value,
an encoding error value, or
a quantity of encoding points for the buffer status report message.

17. The network node of claim 12, wherein the one or more parameter values are based at least in part on at least one of a predicted data size, a resolution, or an encoding rate.

18. The network node of claim 12, wherein the buffer status report table is based at least in part on one or more static parameters, the one or more static parameters including at least one of a maximum quantity of step sizes or a maximum quantity of buffer status report tables.

19. The network node of claim 12, wherein the one or more processors are further configured to:
transmit configuration information associated with configuring the buffer status report table, wherein the configuration information is on a per logical channel group basis.

20. The network node of claim 19, wherein the configuration information configures the buffer status report table for a logical channel group such that a range of the buffer status report table does not overlap with any other range of any other buffer status report table for the logical channel group.

21. The network node of claim 12, wherein the buffer status report message is a medium access control (MAC) control element including at least one of:
a logical channel control group indicator,
a logical channel control group queue indicator,
a buffer status report table indicator, or
a buffer size indicator.

22. The network node of claim 12, wherein the buffer status report table is selected from a set of available buffer status report tables based at least in part on a characteristic of the buffer.

23. A method of wireless communication performed by a user equipment (UE), comprising:
receiving, at a buffer, data for transmission; and
transmitting a buffer status report message regarding the data for transmission, the buffer status report message including an indication of the buffer, the indication of the buffer being encoded using a buffer status report table that is based at least in part on one or more parameter values.

24. The method of claim 23, wherein the buffer status report message includes information identifying the buffer status report table.

25. The method of claim 23, further comprising:
receiving signaling identifying the one or more parameter values via a system information transmission or a dedicated signaling transmission.

26. The method of claim 23, wherein the one or more parameter values includes at least one of:
a minimum reported buffer status value,
a maximum reported buffer status value,
an encoding error value, or
a quantity of encoding points for the buffer status report message.

27. The method of claim 23, wherein the one or more parameter values are selected from a set of possible parameter values based at least in part on at least one of a predicted data size, a resolution, or an encoding rate.

28. The method of claim 23, wherein the buffer status report table is based at least in part on one or more static parameters, the one or more static parameters including at least one of a maximum quantity of step sizes or a maximum quantity of buffer status report tables.

29. A method of wireless communication performed by a network node, comprising:
receiving, from a user equipment (UE), a buffer status report message regarding data, at a buffer of the UE, for transmission, the buffer status report message including an indication of the buffer, the indication of the buffer being encoded using a buffer status report table that is based at least in part on one or more parameter values; and
communicating with the UE based at least in part on a content of the buffer status report message.

30. The method of claim 29, wherein the buffer status report message includes information identifying the buffer status report table.
